(19) United States
(12) Patent Application Publication
(10) Pub. No.: US 2026/0334359 A1
(43) Pub. Date: Oct. 29, 2026

(54) WALK-BEHIND POWER TOOL

(71) Applicant: Nanjing Chervon Industry Co., Ltd., Nanjing (CN)

(72) Inventors: Tianwei Niu, Nanjing (CN); Qi Zhang, Nanjing (CN); Renzhi Zhu, Nanjing (CN); Hongbin Shan, Nanjing (CN); Siyi Li, Nanjing (CN)

(21) Appl. No.: 19/737,854

(22) Filed: Jul. 10, 2026

Related U.S. Application Data
(63) Continuation-in-part of application No. 18/805,620, filed on Aug. 15, 2024.

(30) Foreign Application Priority Data
Aug. 31, 2023 (CN) 202311120477.9
Aug. 31, 2023 (CN) 202322370263.9
Aug. 7, 2025 (CN) 202511106195.2
Oct. 15, 2025 (CN) 202511475975.4

(51) Int. Cl. A01D 34/82; A01D 34/68; A01D 34/78; A01D 75/00; A01D 101/00

(52) U.S. Cl. CPC A01D 34/82; A01D 34/68; A01D 34/78; A01D 75/008; A01D 2101/00

(57) ABSTRACT

A storage system for a mower, including: a mower, a storage box, and a hanging member configured to be fixedly mounted to a wall, wherein the mower includes: a body including a wheel assembly and a cutting assembly, the wheel assembly including front wheels and rear wheels, the cutting assembly including a motor and a cutting blade driven by the motor to rotate, the body further including a coupling portion configured to detachably receive a battery pack to supply power to the motor, the body further including a mounting portion configured to mount the storage box; the storage box includes: a box body, the box body being formed with or connected with an engaging slot matching the hanging member, such that the box body can be suspended on the hanging member.

### CROSS-REFERENCE TO RELATED APPLICATIONS

This application is a continuation-in-part of U.S. Patent Application No. 18/805,620, filed on Aug. 15, 2024, which application claims the benefit under 35 U.S.C. §119(a) of Chinese Patent Application No. 202311120477.9, filed on Aug. 31, 2023, and Chinese Patent Application No. 202322370263.9, filed on Aug. 31, 2023.

This application also claims the benefit under 35 U.S.C. §119(a) of Chinese Patent Application No. 202511106195.2, filed on Aug. 7, 2025, and Chinese Patent Application No. 202511475975.4, filed on Oct. 15, 2025.

Each of these applications to which priority is claimed is incorporated herein by reference in its entirety.

### TECHNICAL FIELD

The present application relates to a power tool and, in particular, to a walk-behind power tool.

### BACKGROUND

A walk-behind power tool in the related art, such as a mower, includes a motor and a cutting blade. The motor is used for driving the cutting blade to rotate to implement cutting, and the energy device is used for supplying power to the motor.

The cutting blade is generally disposed on a middle portion of a machine body, and walking wheels are disposed at the front and rear ends of the machine body. To shorten the distance between the energy device and the motor, the energy device is generally disposed on the middle portion of the machine body so that the motor is located below the energy device. A grass basket of the mower is generally located on a rear portion of the machine body, and the energy device is disposed on the middle portion of the machine body. When the grass basket is filled with grass, the center of gravity of the whole machine is backward, causing a poor balance and a risk of head lifting. Additionally, since the energy device is disposed on the middle portion of the machine body, space in the machine body is wasted and cannot be effectively utilized.

This part provides background information related to the present application, and the background information is not necessarily the existing art.

### SUMMARY

A storage system for a mower, including: a mower, a storage box, and a hanging member configured to be fixedly mounted to a wall, wherein the mower includes: a body including a wheel assembly and a cutting assembly, the wheel assembly including front wheels and rear wheels, the cutting assembly including a motor and a cutting blade driven by the motor to rotate, the body further including a coupling portion configured to detachably receive a battery pack to supply power to the motor, the body further including a mounting portion configured to mount the storage box; the storage box includes: a box body, the box body being formed with or connected with an engaging slot matching the hanging member, such that the box body can be suspended on the hanging member.

In one example, the hanging member is a hook.

In one example, the hanging member is a rail.

In one example, the engaging slot is capable of engaging with the mounting portion and the hanging member respectively.

In one example, the storage box further includes a lid.

In one example, the lid is snap-fitted with the box body.

In one example, the lid is rotatably opened and closed with respect to the box body.

In one example, the lid is slidably opened and closed with respect to the box body.

In one example, the storage box is disposed behind the coupling portion.

In one example, the storage box has a volume of 4-8 L.

In one example, the mower includes a handle assembly, and when the handle assembly is folded, the storage box can be freely removed or mounted without interfering with the handle assembly in the folded state.

In one example, when the mower is stored upright, the storage box does not fall off.

In one example, the storage box further includes a bracket that helps to secure a rod-shaped article.

In one example, the bracket is integrally formed with or detachably connected to the box body.

In one example, the body includes a recess configured to selectively receive the storage box or articles directly.

The present disclosure further provides a walk-behind mower, including: a body including a wheel assembly and a cutting assembly, the wheel assembly including front wheels and rear wheels, the cutting assembly including a motor and a cutting blade driven by the motor to rotate, the body further including a coupling portion configured to detachably receive a battery pack to supply power to the motor; a handle assembly connected to the body for a user to operate the mower from a rear side of the mower; and a storage box disposed on the body, wherein a machine cover of the body is formed with a recess to receive the storage box, and the storage box is detachably mounted to the body.

In one example, the walk-behind mower further includes a lid, and the lid is disposed above the storage box.

In one example, the lid is a mesh surface.

In one example, the lid is rotatably opened and closed with respect to the storage box.

In one example, the lid is slidably opened and closed with respect to the storage box.

In one example, the storage box is disposed in front of the coupling portion.

In one example, the storage box is disposed behind the coupling portion.

In one example, the storage box has a volume of 4-8 L.

In one example, the walk-behind mower further includes a spraying device, the spraying device includes an outlet allowing a substance to be sprayed to flow out, the storage box contains the substance to be sprayed therein, and the outlet is disposed on one side of the storage box and communicates with an accommodation space inside the storage box.

In one example, after the storage box is detached, a plurality of storage boxes can be stacked.

In one example, after the storage box is detached, a plurality of storage boxes can be arranged in an expanded manner.

In one example, when the handle assembly is folded, the storage box can be freely removed or mounted without interfering with the handle assembly in the folded state.

In one example, when the walk-behind mower is stored upright, the storage box does not fall off.

In one example, the storage box is detachably provided with a bracket that helps to secure a rod-shaped article.

The beneficial effects of the present disclosure are: the storage box is detachable, and the storage box can be mounted on the mower or hung on a wall, thereby having wide applicability in various scenarios and improving user convenience.

### BRIEF DESCRIPTION OF THE DRAWINGS

FIG. 1 is a structural view of a mower according to the present application;

FIG. 2 is a side view of a mower according to the present application;

FIG. 3 is a top view of a mower according to the present application;

FIG. 4 is an exploded view one of a mower according to the present application;

FIG. 5 is an exploded view two of a mower according to the present application;

FIG. 6 is a front view of part of the structure of a mower according to the present application;

FIG. 7 is a sectional view of FIG. 6 taken along A-A;

FIG. 8 is a schematic view of projections of a mower according to the present application;

FIG. 9 is a bottom view of part of the structure of a mower according to the present application;

FIG. 10 is a top view of part of the structure of a mower according to the present application;

FIG. 11 is an exploded view of another mower according to the present application;

FIG. 12 is an exploded view of another mower with a rotatable storage portion according to the present application;

FIG. 13 is a top view of another mower according to the present application;

FIG. 14 is a top view of another mower with a rotatable storage portion according to the present application;

FIG. 15 is a top view of a storage portion of another mower according to the present application;

FIG. 16 is a schematic structural view of a storage system for a mower according to an example of the present disclosure;

FIG. 17 is a schematic structural view of a walk-behind mower according to an example of the present disclosure;

FIG. 18 is a side view of a walk-behind mower according to an example of the present disclosure;

FIG. 19 is an exploded schematic structural view of a mower according to an example of the present disclosure;

FIG. 20 is an exploded schematic structural view of the mower according to an example of the present disclosure from another perspective;

FIG. 21 is an exploded schematic structural view of a storage box mounted to a mower according to an example of the present disclosure;

FIG. 22 is a schematic structural view of the storage box mounted on a mower according to an example of the present disclosure;

FIG. 23 is a schematic structural view of a box body closed with a lid according to an example of the present disclosure;

FIG. 24 is a schematic structural view of a storage box according to an example of the present disclosure;

FIG. 25 is a schematic structural view of an engaging slot of a storage box engaged with a hook according to an example of the present disclosure;

FIG. 26 is a schematic structural view of the engaging slot of the storage box engaged with a hook according to an example of the present disclosure from another perspective;

FIG. 27 is a schematic structural view of an engaging slot of a storage box engaged with a rail according to an example of the present disclosure;

FIG. 28 is a schematic structural view of the engaging slot of the storage box engaged with a rail according to an example of the present disclosure from another perspective;

FIG. 29 is a schematic structural view of a plurality of storage boxes stacked according to an example of the present disclosure;

FIG. 30 is a schematic structural view of the plurality of storage boxes stacked according to an example of the present disclosure from another perspective;

FIG. 31 is a schematic structural view of a mower with a handle assembly folded according to an example of the present disclosure;

FIG. 32 is a schematic structural view of a mower with a handle assembly folded according to an example of the present disclosure from another perspective;

FIG. 33 is a schematic structural view showing the removal and mounting of the storage box when the handle assembly of FIG. 31 is folded;

FIG. 34 is a schematic structural view showing the removal and mounting of a box body when the handle assembly is folded according to an example of the present disclosure;

FIG. 35 is a schematic structural view of a mower stored upright according to an example of the present disclosure;

FIG. 36 is a schematic structural view of the mower stored upright according to an example of the present disclosure from another perspective;

FIG. 37 is a schematic structural view of a box body provided with brackets according to an example of the present disclosure;

FIG. 38 is a schematic structural view of the brackets that help secure rod-shaped articles according to an example of the present disclosure; and

FIG. 39 is a schematic structural view of a storage box accommodating rod-shaped articles according to an example of the present disclosure.

### DETAILED DESCRIPTION

Before any examples of this application are explained in detail, it is to be understood that this application is not limited to its application to the structural details and the arrangement of components set forth in the following description or illustrated in the above drawings.

In this application, the terms "comprising", “including”, "having" or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase "comprising a ..." does not preclude the presence of additional identical elements in the process, method, article, or device comprising that element.

In this application, the term "and/or" is a kind of association relationship describing the relationship between associated objects, which means that there can be three kinds of relationships. For example, A and/or B can indicate that A exists alone, A and B exist simultaneously, and B exists alone. In addition, the character "/" in this application generally indicates that the contextual associated objects belong to an "and/or" relationship.

In this application, the terms "connection", "combination", "coupling" and "installation" may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, "connection" and "coupling" are not limited to physical or mechanical connections or couplings, and may include electrical connections or couplings.

In this application, it is to be understood by those skilled in the art that a relative term (such as "about", "approximately", and "substantially") used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, "substantially" when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms "up", "down", "left", "right", "front", and "rear" and other directional words are described based on the orientation or positional relationship shown in the drawings, and should not be understood as limitations to the examples of this application. In addition, in this context, it also needs to be understood that when it is mentioned that an element is connected "above" or "under" another element, it can not only be directly connected "above" or "under" the other element, but can also be indirectly connected "above" or "under" the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms "controller", "processor", "central processor", "CPU" and "MCU" are interchangeable. Where a unit "controller", "processor", "central processing", "CPU", or "MCU" is used to perform a specific function, the specific function may be implemented by a single aforementioned unit or a plurality of the aforementioned unit.

In this application, the term "device", "module" or "unit" may be implemented in the form of hardware or software to achieve specific functions.

In this application, the terms "computing", "judging", "controlling", "determining", "recognizing" and the like refer to the operations and processes of a computer system or similar electronic computing device (e.g., controller, processor, etc.).

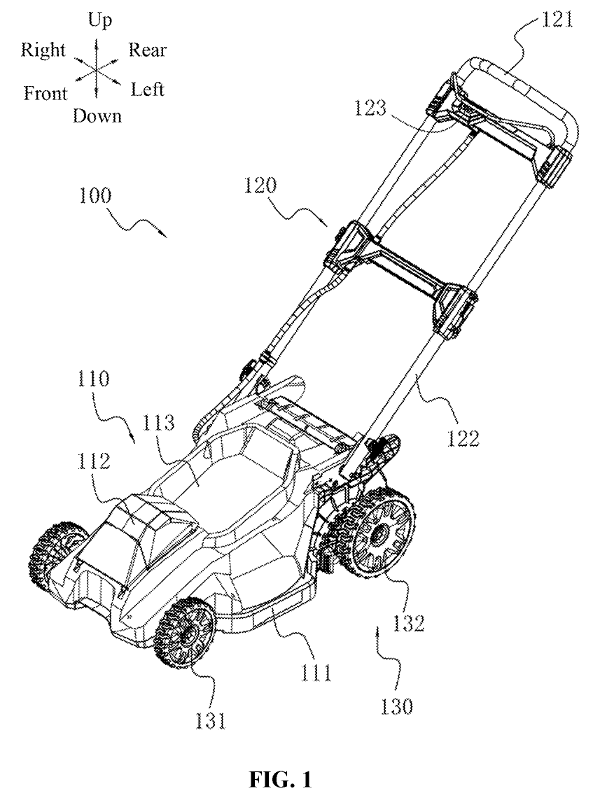

A walk-behind power tool shown in FIG. 1 is used for a user to cut grass in a lawn, such as a lawn of a garden or a golf course. The grass in the lawn requires regular care and thus needs to be often cut with the walk-behind power tool. In this example, the walk-behind power tool is a mower 100. When the user operates the mower 100, the user stands behind the mower 100 to push the mower 100 to walk on the ground.

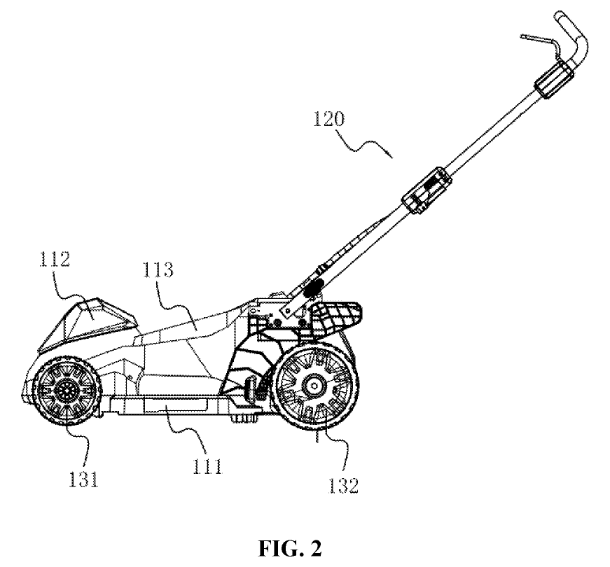

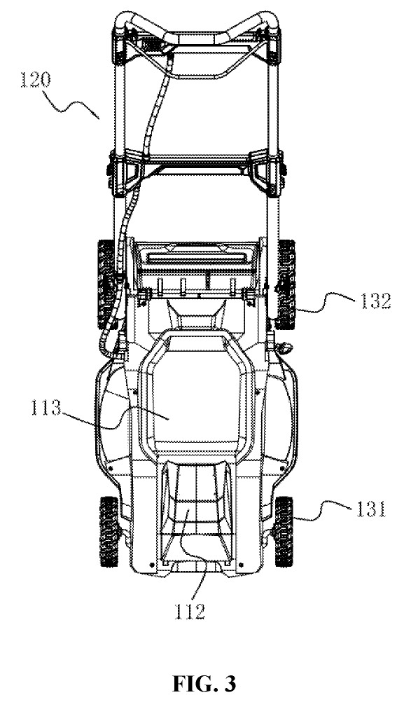

As shown in FIGS. 1 to 3, the mower 100 includes a body 110, a handle device 120, and a walking assembly 130.

The handle device 120 is connected to the body 110. The mower 100 has a moving state in which the body 110 and at least part of the handle device 120 move relatively. In a process of the body 110 and at least part of the handle device 120 moving relatively, the mower 100 is in the moving state. In this example, the handle device 120 may be pivotally connected to the body 110. In the moving state, the handle device 120 rotates relative to the body 110. In some examples, the handle device 120 is fixedly connected to the body 110. The handle device 120 is configured for the user to operate. The handle device 120 includes a holding end 121 and connecting rods 122, the holding end 121 is used for the user to hold to push or support the mower 100, and the connecting rods 122 connect the holding end 121 to the body 110. The handle device 120 further includes a trigger 123 disposed on the holding end 121. The trigger 123 is for the user to press to control the mower 100 to mow the grass.

The walking assembly 130 includes two front walking wheels 131 and two rear walking wheels 132. The walking assembly 130 can at least drive the mower 100 to advance, retreat, and turn on the ground. The walking assembly 130 supports the body 110 and the handle device 120.

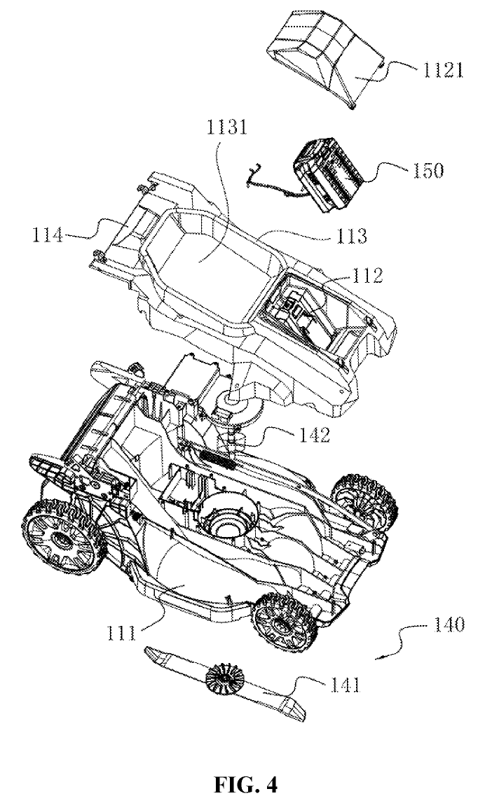

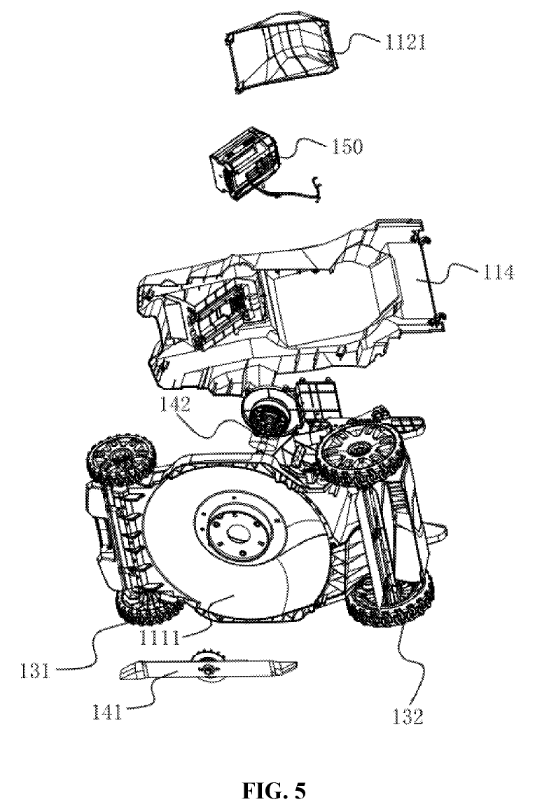

As shown in FIGS. 4 and 5, the mower 100 further includes a working assembly 140. The body 110 accommodates at least part of the working assembly 140. The working assembly 140 includes a working member 141 and a motor 142, and the motor 142 is configured to drive the working member 141 to move. The body 110 includes a deck 111. The deck 111 is formed with an accommodation space 1111 for accommodating at least part of the working member 141. The accommodation space 1111 is open downward, and the working member 141 is disposed in the accommodation space 1111. The motor 142 is mounted to the deck 111, and the working member 141 is mounted to the motor 142 to be driven by the motor 142. The working member 141 may be a blade. One or more blades may be provided. The motor 142 may be an electric motor. The electric motor drives the blade to rotate at a high speed to mow the grass.

The body 110 supports the working assembly 140. The body 110 connects the walking assembly 130, the working assembly 140, and the handle device 120 into a whole. The body 110 further includes a coupling portion 112 configured to accommodate an energy device 150. The energy device 150 is a battery pack, and the battery pack is used for providing power for the mower 100. Specifically, the energy device 150 is configured to provide energy for the motor 142. In other examples, the coupling portion 112 may be connected to a cable, and the cable may be connected to a mains electricity grid. In other examples, the coupling portion 112 may be connected to another energy device. For example, the coupling portion 112 may be connected to a fuel tank, and fuel in the fuel tank may provide energy for the mower 100.

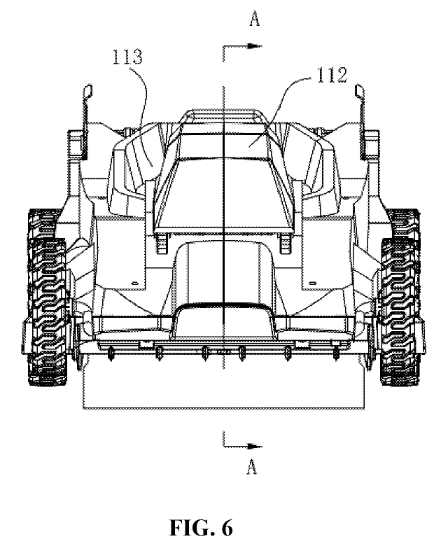

Referring to FIGS. 1 to 8, the body 110 further includes a storage portion 113 configured to store an article, the body 110 has a foremost end 110a of the body, and at least part of the coupling portion 112 is disposed between the foremost end 110a of the body and the storage portion 113. In a front and rear direction, the foremost end of the body, the coupling portion, and the storage portion are arranged in sequence. A projection of the storage portion 113 on the ground is defined as a first projection P1, a projection of the working member 141 in rotation on the ground is defined as a second projection P2, and at least part of the first projection P1 overlaps the second projection P2. The projections of the storage portion 113 and the working member 141 in rotation on the ground at least partially overlap. Projections of the storage portion 113 and the motor 142 on the ground at least partially overlap.

The storage portion 113 is disposed so that a storage space is added to allow the user to place articles, tools, garbage, and the like. The projection of the storage portion 113 on the ground is the first projection P1, the projection of the working member 141 in rotation on the ground is the second projection P2, and at least part of the first projection P1 overlaps the second projection P2. Thus, at least part of the storage portion 113 is disposed on a middle portion of the body 110. At least part of the coupling portion 112 is disposed between the foremost end 110a of the body and the storage portion 113 so that the battery pack is placed forward, and the center of gravity of the whole machine moves forward. Even if a grass basket is filled with grass, a balance can be ensured.

An overlapping portion between the first projection P1 and the second projection P2 is defined as a third projection P3, and the area ratio of the third projection P3 to the first projection P1 is greater than or equal to 0.5 and less than or equal to 1. It is ensured that most of the storage portion 113 is disposed on the middle portion of the body 110, ensuring the balance of the whole machine. In some examples, the area ratio of the third projection P3 to the first projection P1 equals 0.5, 0.6, 0.7, 0.8, 0.9, or 1.

A projection of the coupling portion 112 on the ground is defined as a fourth projection P4, and the area ratio of the fourth projection P4 to the first projection P1 is greater than or equal to 0.3 and less than or equal to 2. In some examples, the area ratio of the fourth projection P4 to the first projection P1 is greater than or equal to 0.8 and less than or equal to 1.5. In some examples, the area ratio of the fourth projection P4 to the first projection P1 equals 0.3, 0.5, 0.8, 1, 1.2, 1.5, 1.8, or 2.

An overlapping portion between the fourth projection P4 and the second projection P2 is defined as a fifth projection P5, and the area ratio of the fifth projection P5 to the second projection P2 is greater than or equal to 0 and less than or equal to 0.2. In some examples, the area ratio of the fifth projection P5 to the second projection P2 equals 0, 0.1, or 0.2.

At least part of the storage portion 113 has a continuous and smooth bottom surface 1131, a projection of the bottom surface 1131 on the ground is defined as a sixth projection P6, and the area ratio of the sixth projection P6 to the second projection P2 is greater than or equal to 0.3 and less than or equal to 0.9. In some examples, the area ratio of the sixth projection P6 to the second projection P2 equals 0.3, 0.4, 0.5, 0.6, 0.7, 0.8, or 0.9. In this example, the bottom surface 1131 of the whole storage portion 113 is continuous and smooth. The smooth bottom surface 1131 is pleasing and allows the user to conveniently place an article with a relatively large volume, and the stored article can be supported by the bottom surface 1131 and has high stability. It is to be noted that the continuous and smooth bottom surface 1131 is used for representing a basic shape of the bottom surface 1131 and not intended to limit the roughness of the bottom surface 1131. In some examples, granular protrusions or a rubber pad is disposed on the bottom surface 1131 to increase a friction force exerted by the bottom surface 1131 on the stored article.

In the drawings, P1 represents the first projection, P2 represents the second projection, P3 represents the third projection, P4 represents the fourth projection, P5 represents the fifth projection, and P6 represents the sixth projection.

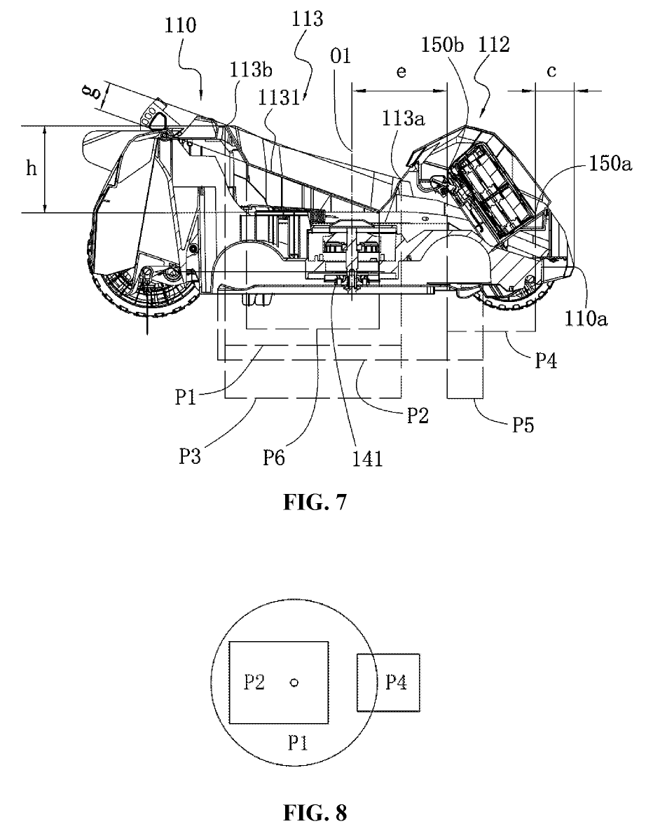

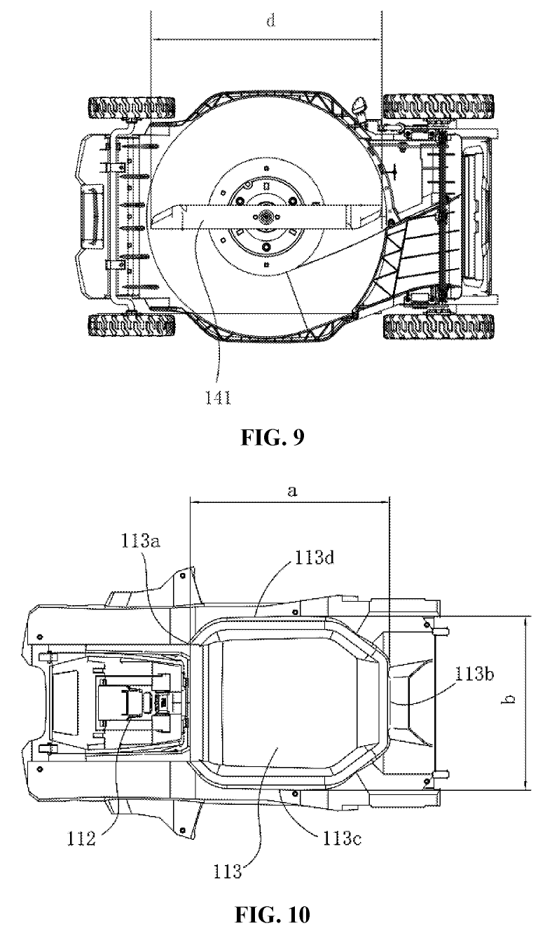

As shown in FIGS. 7 and 9, since the working member 141 is driven by the motor 142 to rotate, the second projection P2 is basically circular. The diameter of the second projection P2 is greater than or equal to 350 mm and less than or equal to 600 mm. In FIG. 9, d represents a maximum diameter of the working member 141, that is, the diameter of the second projection P2. Additionally, the first projection P1 may be circular, rectangular, or in another shape, so the third projection P3 may have an irregular shape.

The storage portion 113 can store an article. Therefore, the storage portion 113 is formed with an accommodation space, and the article can be placed in the accommodation space. The accommodation space has a maximum water storage depth g. In FIG. 7, g represents the maximum water storage depth of the accommodation space. The maximum water storage depth g of the accommodation space is a maximum depth of water after the accommodation space is filled with a maximum volume of water that the accommodation space can accommodate. It is to be noted that when the maximum water storage depth is measured, an angle at which the storage portion 113 is placed is not limited. That is to say, the storage portion 113 may have the maximum water storage depth g when located obliquely, horizontally, or at any other position. The first projection P1 may be circular, rectangular, or in another shape, and the bottom surface 1131 of the accommodation space may be a planar surface, a curved surface, or an uneven surface. The ratio of the maximum water storage depth g to the length of a longest part of the first projection P1 is greater than or equal to 0.1 and less than or equal to 0.3. In some examples, the ratio of the maximum water storage depth g to the length of the longest part of the first projection P1 equals 0.1, 0.2, or 0.3. The ratio of the maximum water storage depth g to the length of the longest part of the first projection is relatively small, the accommodation space has a relatively large storage area and a relatively shallow storage depth so that the user can conveniently place the article with a relatively large volume, and the bottom surface 1131 is relatively close to the user so that the user can conveniently fetch the article without squatting.

The maximum water storage depth g of the accommodation space is greater than or equal to 30 mm and less than or equal to 200 mm. In some examples, the maximum water storage depth g of the accommodation space is greater than or equal to 50 mm and less than or equal to 150 mm. In some examples, the maximum water storage depth g of the accommodation space is greater than or equal to 100 mm and less than or equal to 120 mm.

The accommodation space has a vertical height h. In FIG. 7, h represents the vertical height of the accommodation space. The vertical height h of the accommodation space is the vertical distance from a highest point of an upper edge of the accommodation space to a lowest point of the bottom surface 1131 of the accommodation space in a vertical direction. The vertical height h of the accommodation space is greater than or equal to 20 mm and less than or equal to 300 mm. In some examples, the vertical height h of the accommodation space is greater than or equal to 50 mm and less than or equal to 250 mm. In some examples, the vertical height h of the accommodation space is greater than or equal to 100 mm and less than or equal to 200 mm.

The storage portion 113 has a foremost end 113a of the storage portion and a rearmost end 113b of the storage portion, the distance L between the foremost end 113a of the storage portion and the rearmost end 113b of the storage portion is the length of the storage portion 113, and a horizontal distance a between the foremost end 113a of the storage portion and the rearmost end 113b of the storage portion is the length of the second projection P2 in the front and rear direction. It is to be understood that the storage portion 113 may be horizontally placed on the body 110 or may be obliquely placed to make full use of space. Therefore, the length L of the storage portion 113 is greater than or equal to the length a of the second projection in the front and rear direction.

The horizontal distance a between the foremost end 113a of the storage portion and the rearmost end 113b of the storage portion is greater than or equal to 200 mm and less than or equal to 500 mm. In FIG. 10, a represents the horizontal distance between the foremost end 113a of the storage portion and the rearmost end 113b of the storage portion.

The storage portion 113 has a leftmost end 113c of the storage portion and a rightmost end 113d of the storage portion, and a horizontal distance b between the leftmost end 113c of the storage portion and the rightmost end 113d of the storage portion is greater than or equal to 150 mm and less than or equal to 400 mm. In FIG. 10, b represents the horizontal distance between the leftmost end 113c of the storage portion and the rightmost end 113d of the storage portion.

The storage portion 113 has the rearmost end 113b of the storage portion, and a projection of the rearmost end 113b of the storage portion on the ground is located behind the second projection P2. Thus, the storage portion 113 has a relatively large length on the body 110 to make full use of space in an upper portion of the body 110. The rearmost end 113b of the storage portion does not exceed a rearmost end of the rear walking wheels 132 to ensure the balance of the whole machine.

In some examples, the storage portion 113 includes one storage region which is relatively large and can accommodate a relatively large article. In some examples, the storage portion 113 includes at least two storage regions, and adjacent storage regions are separated by a barrier portion. Since the storage regions are separated from each other, different articles may be placed in different regions as required.

Part of the body 110 is recessed downward to form the storage portion 113, or a housing is connected to the body 110 to form the storage portion 113. The body 110 includes the deck 111 and a machine cover 114 disposed at least partially over the deck 111. The motor 142 is disposed between the deck 111 and the machine cover 114, and components such as wires and a controller are further disposed in a space enclosed between the machine cover 114 and the deck 111. The machine cover 114 protects these components. In this example, the machine cover 114 is formed with the storage portion 113. The machine cover 114 is sunk to form the storage portion 113 so that no new component needs to be added, the structure is simplified, and the space in the upper portion of the body 110 is fully utilized.

The coupling portion 112 can accommodate the energy device 150. In this example, the machine cover 114 is formed with the coupling portion 112, ensuring integrity and facilitating machining and production. In other examples, a detachable coupling portion 112 may be disposed. The machine cover 114 is sunk to form an accommodation cavity serving as the coupling portion 112 to accommodate the energy device 150. A cover 1121 may be disposed over the cavity to shield the energy device 150 and prevent dust from contaminating the energy device 150. An end of the cover 1121 is rotatably connected to the machine cover 114, and the other end of the cover 1121 is engaged with the machine cover 114 so that it is convenient to open the cover 1121 and take out or put in the energy device 150.

The energy device 150 may be inserted into the coupling portion 112 along the vertical direction or a horizontal direction. In this example, an acute angle exists between a direction in which the energy device 150 is inserted and pulled out and a horizontal plane to reduce the height of the whole machine.

The energy device 150 has a foremost end 150a of the energy device, and the distance between the foremost end 150a of the energy device and the foremost end 110a of the body is greater than or equal to 50 mm and less than or equal to 250 mm. In the drawings, c represents the distance between the foremost end 150a of the energy device and the foremost end 110a of the body. In some examples, the distance between the foremost end 150a of the energy device and the foremost end 110a of the body is greater than or equal to 80 mm and less than or equal to 150 mm. In some examples, the distance between the foremost end 150a of the energy device and the foremost end 110a of the body is greater than or equal to 100 mm and less than or equal to 120 mm.

In this example, the foremost end 150a of the energy device is located behind the foremost end 110a of the body. In other examples, the foremost end 150a of the energy device may be located before the foremost end 110a of the body.

The motor 142 is configured to rotate around a motor axis O1, the energy device 150 has a rearmost end 150b of the energy device, the rearmost end 150b of the energy device is located before the motor axis O1, and the distance between the rearmost end 150b of the energy device and the motor axis O1 is greater than or equal to 5 mm and less than or equal to 200 mm. In the drawings, e represents the distance between the rearmost end 150b of the energy device and the motor axis O1. In some examples, the distance between the rearmost end 150b of the energy device and the motor axis O1 is greater than or equal to 20 mm and less than or equal to 150 mm. In some examples, the distance between the rearmost end 150b of the energy device and the motor axis O1 is greater than or equal to 50 mm and less than or equal to 120 mm. In some examples, the distance between the rearmost end 150b of the energy device and the motor axis O1 is greater than or equal to 80 mm and less than or equal to 200 mm. The rearmost end 150b of the energy device is located before the motor axis O1, and the energy device 150 is positioned forward to provide more space for the storage portion 113 so that the storage portion 113 increases in volume and can store larger articles and more articles. The energy device 150 has a relatively large weight. The energy device 150 is moved forward so that the center of gravity of the mower 100 moves forward, and the mower 100 has further improved stability and use comfort.

In some examples, at least part of the storage portion 113 includes a drain channel 1132 configured to guide water in the storage portion 113 to flow out. During raining or cleaning, water is not easy to accumulate in the storage portion 113. A shape of the drain channel and the number of drain channels are not limited, the drain channel may be strip-shaped or hole-shaped, and one or more drain channels may be provided. In some examples, a plug may be disposed at an end of the drain channel to conveniently block the drain channel.

In some examples, an upper cover 115 is disposed over the storage portion 113, and the upper cover 115 enables the accommodation space of the storage portion 113 to be opened or closed. The upper cover can not only protect the article in the storage portion 113 but also prevent impurities such as dust from contaminating the accommodation space. The upper cover is engaged with the machine cover 114. Alternatively, an end of the upper cover is rotatably connected to the machine cover 114, and the other end of the upper cover is engaged with the machine cover 114. The upper cover is not considered as part of the storage portion 113. Therefore, the first projection P1 of the storage portion 113 on the ground does not include a projection of the upper cover. The upper cover may be larger than the storage portion 113, or the upper cover shields only part of the storage portion 113.

The storage portion 113 shown in FIGS. 1 to 10 is integrally formed with the machine cover 114 and not easy to detach. In some examples, at least part of the storage portion 113 is movable so that articles in the storage portion 113, such as weeds, leaves, water, or garbage, are easy to dump. In some examples, the storage portion 113 is rotatable to facilitate dumping and cleaning. In some examples, the storage portion 113 is detachable to facilitate dumping, cleaning, and replacement.

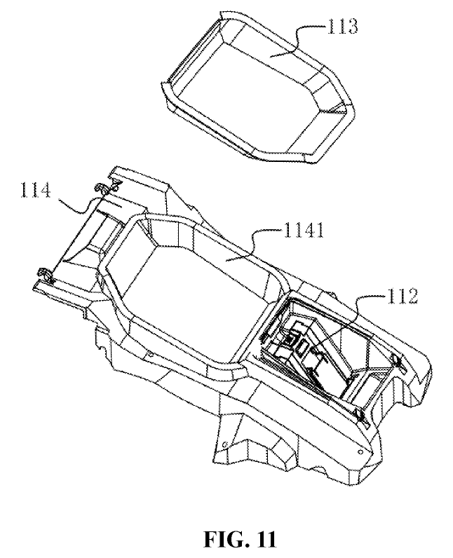

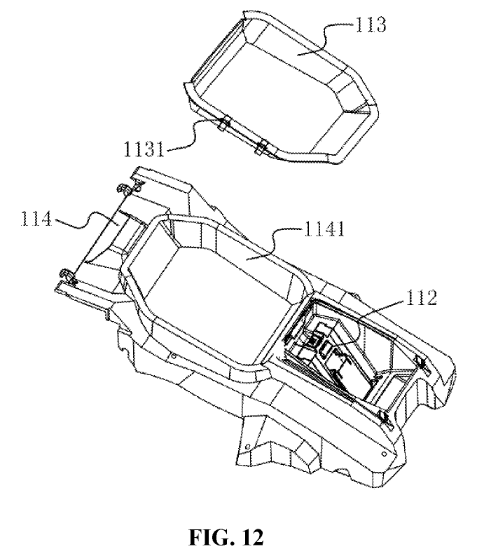

Referring to FIGS. 11 and 12, the machine cover 114 is sunk to form a mounting portion 1141, and the storage portion 113 is movably disposed in the mounting portion 1141. As shown in FIG. 11, the storage portion 113 is inserted into the mounting portion 1141. Since the mounting portion 1141 is disposed on an upper portion of the machine cover 114 and recessed downward, the storage portion 113 can be limited by inner walls or edges of the mounting portion 1141. When installed, the storage portion 113 is inserted downward into the mounting portion 1141. When detached, the storage portion 113 is lifted upward. As shown in FIG. 12, an end of the storage portion 113 is rotatably connected to the mounting portion 1141, and the storage portion 113 is inserted into the mounting portion 1141. When dumping is required, the storage portion 113 is just rotated. As shown in FIG. 12, a spindle 1131 is disposed on the right side of the storage portion 113 and the storage portion 113 is rotatably connected to the machine cover 114 through the spindle 1131.

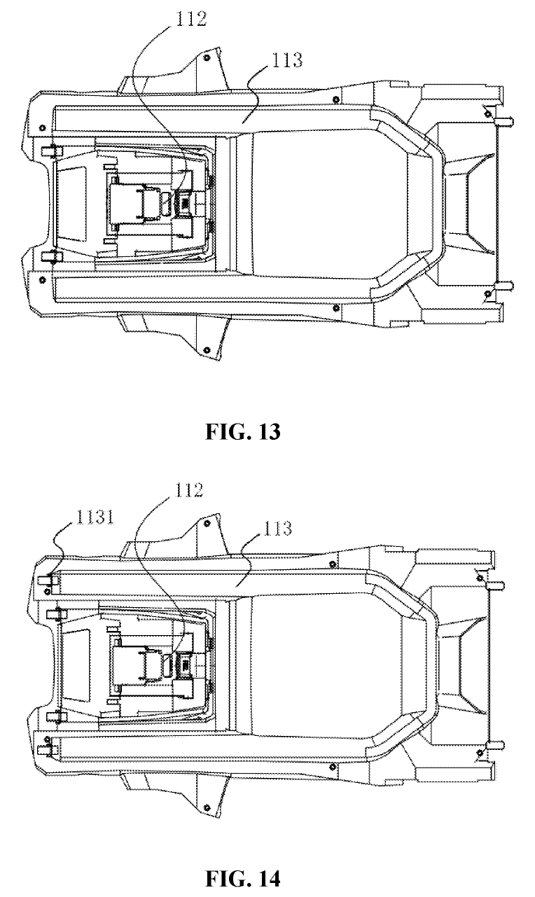

In the mower 100 shown in FIGS. 1 to 12, the storage portion 113 is entirely disposed on the rear side of the coupling portion 112. In some examples, part of the storage portion 113 is disposed on the rear side of the coupling portion 112, and at least part of the storage portion 113 is distributed on the left side or the right side of the coupling portion 112 to make full use of space around the coupling portion 112. As shown in FIG. 13, part of the storage portion 113 is disposed on the rear side of the coupling portion 112, and part of the storage portion 113 is distributed on the left side and the right side of the coupling portion 112.

As shown in FIG. 14, when at least part of the storage portion 113 is distributed on the left side or the right side of the coupling portion 112, the storage portion 113 is rotatably connected to the machine cover 114. Specifically, the spindle 1131 may be disposed at the front end of the storage portion 113 and the storage portion 113 is rotatably connected to the machine cover 114 through the spindle 1131. When dumping is required, the storage portion 113 is just rotated.

The storage portion 113 and the coupling portion 112 may be integrated or disposed separately.

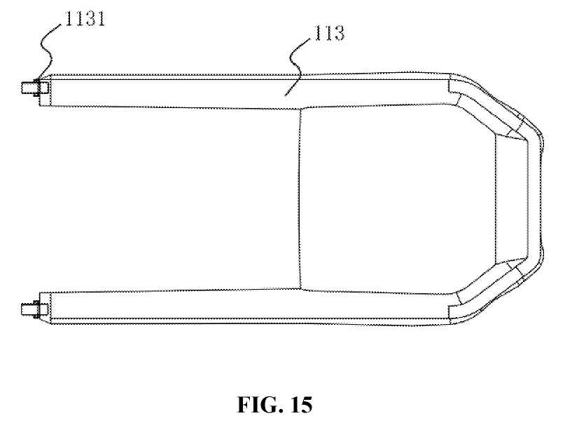

When the storage portion 113 and the coupling portion 112 are disposed separately, in the case where the storage portion 113 is rotatably connected to the machine cover 114, the storage portion 113 needs to be prevented from interfering with the coupling portion 112. As shown in FIG. 15, the storage portion 113 is basically U-shaped to avoid the coupling portion 112. When dumping is required, the storage portion 113 is rotated and the coupling portion 112 remains fixed.

When the storage portion 113 and the coupling portion 112 are integrated, in the case where the storage portion 113 is rotatably or detachably connected to the machine cover 114, the coupling portion 112 moves with the storage portion 113 when dumping is required. When the storage portion 113 is reset after dumping, the coupling portion 112 is reset. It is to be understood that when the coupling portion 112 moves with the storage portion 113, the energy device 150 in the coupling portion 112 is driven to move together. Therefore, it needs to be ensured that the energy device 150 can supply power normally after being moved. Generally, a wire needs to increase in length.

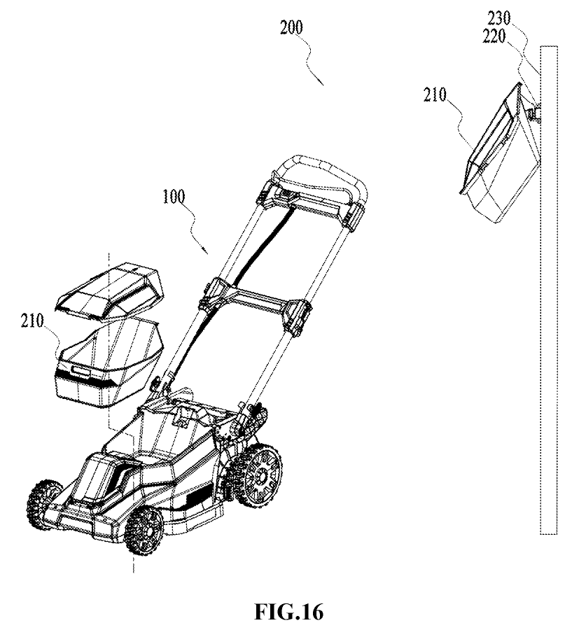

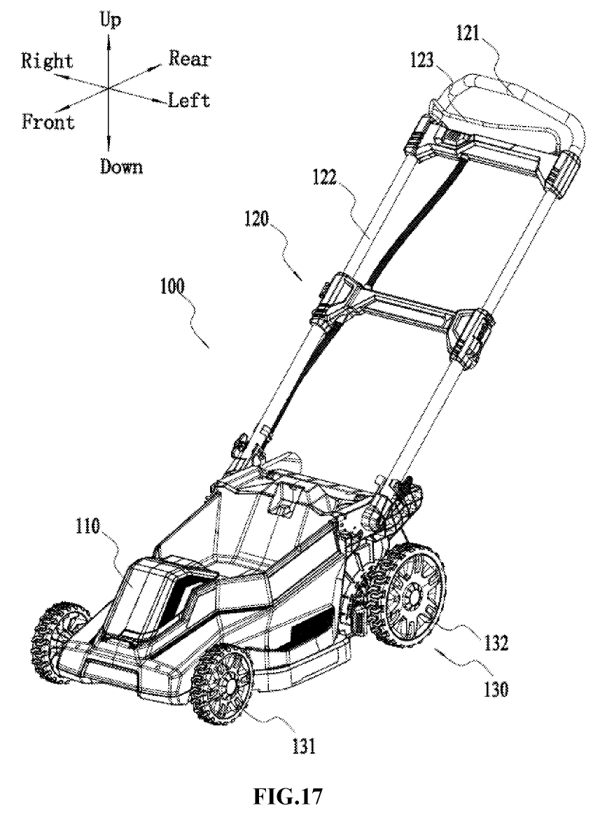

FIG. 16 is a schematic structural view of a storage system for a mower according to an example of the present disclosure. The mower may be a push mower or a self-propelled walk-behind mower. When a user operates the mower 100, the user stands behind the mower 100 to push the mower 100 to walk on the ground.

As shown in FIG. 16, the storage system 200 for a mower according to an example of the present disclosure includes a mower 100, a storage box 210, and a hanging member 220. The hanging member 220 is configured to be fixedly mounted to a wall 230. The storage box 210 is detachable. The storage box 210 can be mounted on the mower 100, and can also be suspended on the wall 230, thereby having wide applicability in various scenarios and improving user convenience.

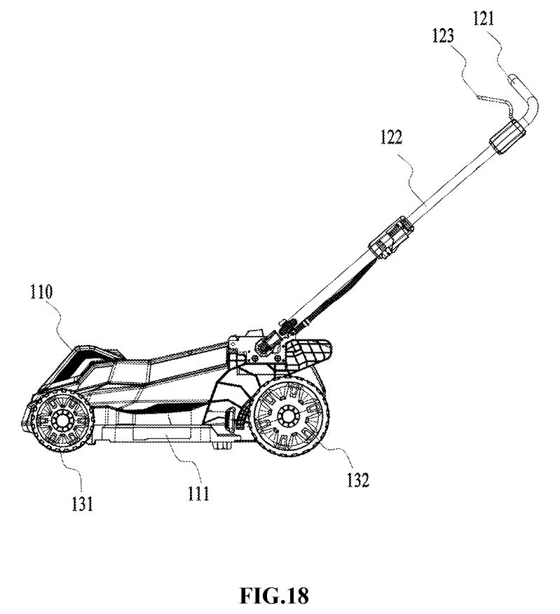

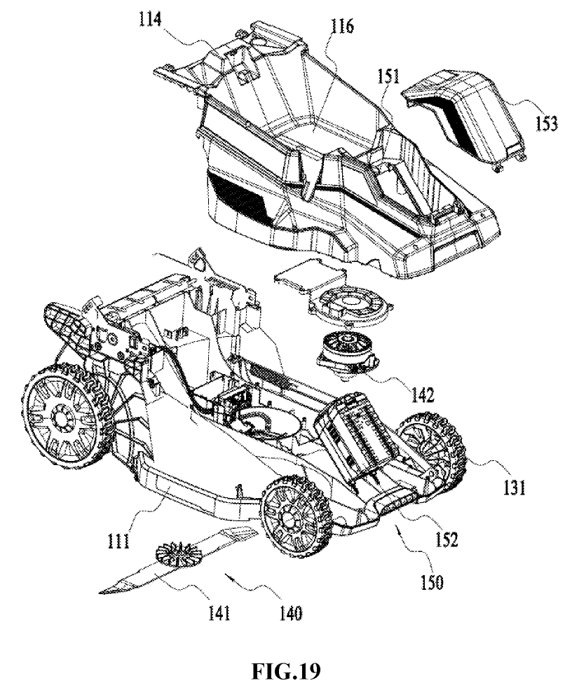

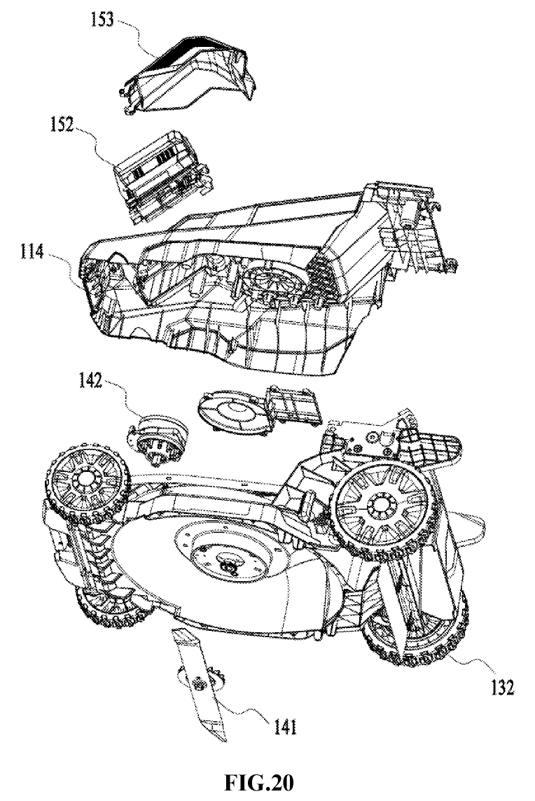

As shown in FIGS. 17 to 20, schematic structural views of the walk-behind mower are shown. To clearly describe the technical solution of the present disclosure, directions as shown in FIG. 17 are also defined: front, rear, left, right, up, and down, wherein the front-rear direction may also be understood as the length direction of the mower, the left-right direction may be understood as the width direction of the mower, and the up-down direction may be understood as the height direction of the mower.

As shown in FIGS. 17 to 20, the mower 100 mainly includes a body 110 and a handle assembly 120. The body 110 includes a wheel assembly 130, a cutting assembly 140, and an energy device 150. The wheel assembly 130 is a wheel assembly including front wheels 131 and rear wheels 132 arranged in the front-rear direction. The wheel assembly 130 can at least drive the mower 100 to move forward, backward, and turn on the ground. The wheel assembly 130 supports the body 110 and the handle assembly 120. The cutting assembly 140 includes a cutting blade 141 and a motor 142 driving the cutting blade 141 to rotate. The motor 142 is configured to drive the cutting blade 141 to cut grass. The body 110 includes a deck 111. A cutting space for receiving at least part of the cutting blade 141 is formed at a bottom portion of the deck 111, and the cutting space opens downward. The cutting blade 141 is disposed in the cutting space. The motor 142 is mounted to the deck 111, and the cutting blade 141 is mounted to the motor 142 to be driven by the motor 142. The cutting blade 141 may be one or more. The motor 142 may be an electric motor, and the electric motor drives the cutting blade 141 to rotate at high speed to cut grass. The body 110 includes a coupling portion 151. The coupling portion 151 detachably receives a battery pack 152. After the battery pack 152 is mounted to the coupling portion 151, it supplies power to the cutting assembly 140. Specifically, the battery pack 152 at least supplies power to the motor 142. The battery pack 152 may be a battery pack with a rated voltage of 24V, 36V, 40V, or 56V, and the capacity of the battery pack 152 is not specifically limited.

The handle assembly 120 is connected to the body 110. In this example, the handle assembly 120 is pivotably connected to the body 110. In a moving state, the handle assembly 120 rotates relative to the body 110. In some examples, the handle assembly 120 is fixedly connected to the body 110. The handle assembly 120 is configured for a user to operate. The handle assembly 120 allows the user to operate the mower from the rear side of the mower 100. The handle assembly 120 includes a grip portion 121 and a connecting rod 122. The grip portion 121 is for the user to grip to push or hold the mower 100. The connecting rod 122 connects the grip portion 121 and the body 110. The handle assembly 120 further includes a trigger 123. The trigger 123 is provided on the grip portion 121. The trigger 123 operable by the user to control the mower 100 to perform mowing.

The body 110 includes a deck 111 and a machine cover 114 at least partially disposed above the deck 111. The motor 142 is disposed between the deck 111 and the machine cover 114. The space enclosed by the machine cover 114 and the deck 111 also accommodates wires, a controller, and other components. The machine cover 114 protects these components. A cover 153 is formed at a front end of the machine cover 114. The cover 153 shields the battery pack 152 to prevent dust from contaminating the battery pack 152. One end of the cover 153 is rotatably connected to the machine cover 114, and the other end of the cover 153 is snap-fitted with the machine cover 114, facilitating opening of the cover 153 to access the battery pack 152.

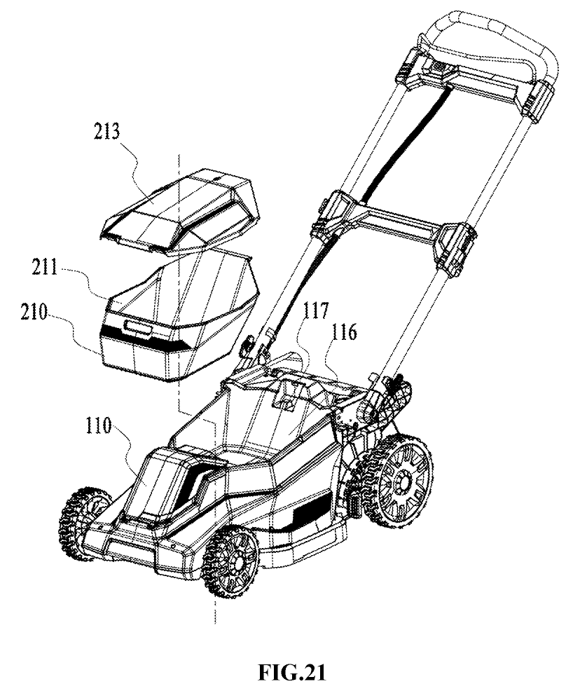

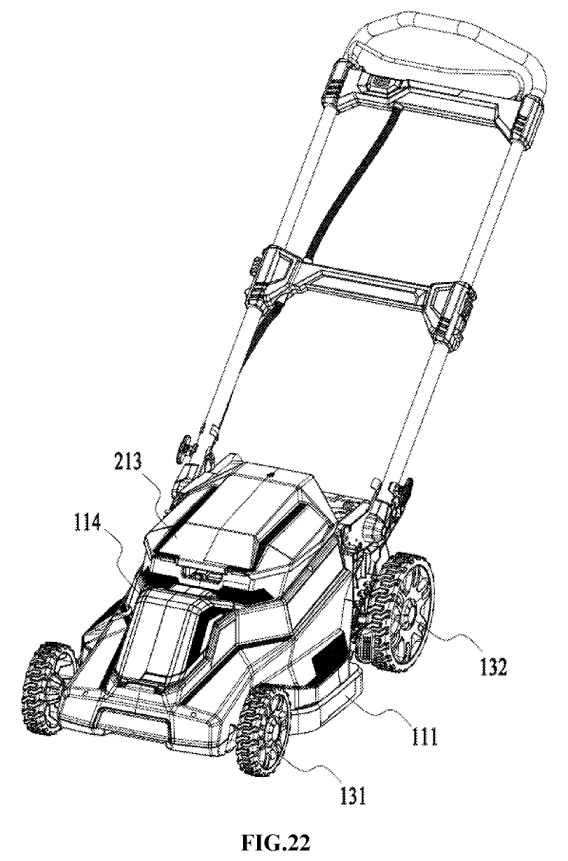

As shown in FIGS. 21 and 22, the storage box 210 is configured to store articles. The storage box 210 can be mounted to the body 110 of the mower 100 for storing accessories and maintenance tools related to the mower 100. In this example, the machine cover 114 is sunk to form a recess 116 for receiving the storage box 210. The body 110 further includes a mounting portion 117 configured to mount the storage box 210. The storage box 210 is received in the recess 116 and detachably mounted to the mounting portion 117. By sinking the machine cover 114 to form the recess 116, no additional components are required, the structure is simplified, and the space above the body 110 is fully utilized. The storage box 210 is mounted in the recess 116 and can store accessories and maintenance tools related to the mower 100, facilitating the user to replace the cutting blade of the mower 100 and perform timely maintenance on the mower 100. The storage box 210 can also protect the surface of the recess 116, preventing the user from directly using the accommodation space of the recess 116 for storage and causing damage to the inner wall of the recess 116. Providing the storage box 210 as detachable also allows the user to replace the storage box 210 to meet requirements for article volume, material, and the like. That being said, when the storage box 210 is removed, the recess 116 may also receive articles directly, serving as a temporary storage space.

The storage box 210 is at least partially received in the accommodation space formed by the recess 116. It can be understood that the storage box 210 may be completely received in the recess 116, i.e., the accommodation space formed by the storage box 210 is entirely within the accommodation space formed by the recess 116, or the storage box 210 may be partially received in the recess 116 and partially extend out of the recess 116. The storage box 210 may be placed horizontally or obliquely on the machine cover 114. In this example, based on the layout of the components of the body 110, in order to fully utilize the space of the body 110, in the front-rear direction, the storage box 210 extends from the rear end of the battery pack 152 rearward to the rear end of the machine cover 114; in the left-right direction, the storage box 210 extends from the left edge of the machine cover 114 to the right edge; and in the up-down direction, the bottom end of the storage box 210 extends to near the top end of the motor 142.

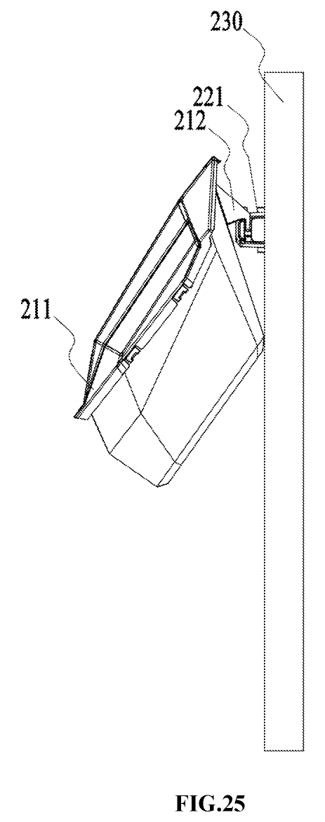

As shown in FIGS. 16 and 25, the storage box 210 can also be detached from the mounting portion 117 of the body 110 and suspended on the hanging member 220 on the wall 230. For example, the hanging member 220 is fixed to the wall 230 of a tool room, and one end of the storage box 210 is suspended on the hanging member 220 to store accessories and tools of the mower 100, or as a storage box for other articles.

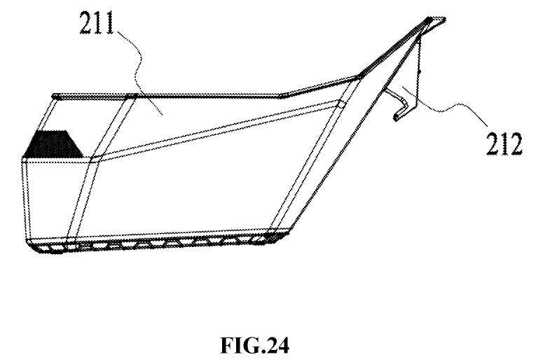

Specifically, as shown in FIG. 24, the storage box 210 includes a box body 211. The box body 211 is provided with an engaging slot 212. The engaging slot 212 can respectively match the mounting portion 117 on the mower 100 and the hanging member 220 on the wall 230. The engaging slot 212 is formed in the box body 211, i.e., the engaging slot 212 is integrally formed with the box body 211, or the engaging slot 212 is mounted to the box body 211, i.e., the engaging slot 212 and the box body 211 are separate parts and fixedly connected. When the storage box 210 is mounted on the mower 100, the engaging slot 212 on the box body 211 matches the mounting portion 117 on the machine cover 114 to fix the storage box 210, and the engaging slot 212 is engaged with the mounting portion 117, so that the storage box 210 is fixed in the recess 116. When the storage box 210 is suspended on the wall 230, the engaging slot 212 matches the hanging member 220 to suspend the storage box 210 on the hanging member 220. In one example, the engaging slot 212 is detachably connected to the box body 211. When the storage box 210 is mounted on the mower 100, the engaging slot 212 is detached from the box body 211. When the storage box 210 is suspended on the wall 230, the engaging slot 212 is mounted to the box body 211, and the storage box 210 is suspended on the hanging member 220 by matching the engaging slot 212 with the hanging member 220. Suspending the storage box 210 on the wall 230, compared with stacking on the floor, saves floor space and keeps the overall space neat.

In the storage system of the present disclosure, the storage box 210 is detachable. The storage box 210 can be mounted on the body 110 of the mower 100 for storing articles, and can also be detached and separately placed, or suspended on the wall 230, thereby being applicable in various scenarios, achieving multiple purposes, and having flexible use and wide applicability.

The hanging member 220 is fixedly mounted to the wall 230 by a fastener. The fastener may be a screw or bolt, or an adhesive. The engaging slot 212 may be disposed at any position on a side surface of the box body 211. Exemplarily, the engaging slot 212 is located on a side surface of the box body 211 along the width direction, or on a side surface along the length direction, which is not limited herein.

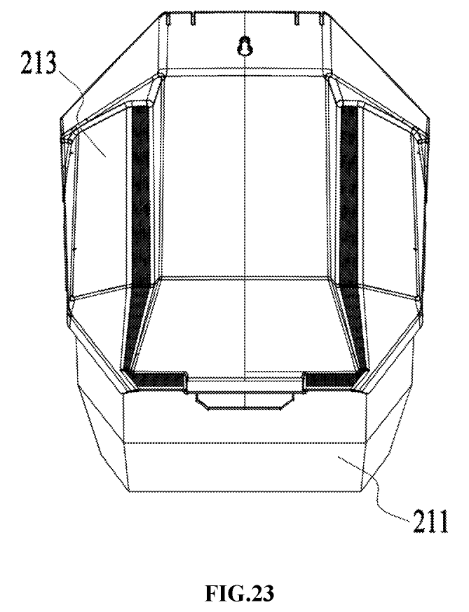

As shown in FIG. 23, the storage system 200 further includes a lid 213. The lid 213 can open or close the accommodation space of the box body 211. The lid 213 not only protects the articles in the storage box 210, but also prevents impurities such as dust from contaminating the accommodation space. The lid 213 is snap-fitted with the box body 211. In some examples, the lid 213 is slidably opened and closed with respect to the box body 211, i.e., the lid 213 is slidable relative to the box body 211 to achieve opening and closing. In some examples, one end of the lid 213 is rotatably connected (i.e., hinged) to the box body 211, and the other end of the lid 213 is snap-fitted with the box body 211. The lid 213 is rotatably opened and closed with respect to the box body 211, and the lid 213 can rotate about an axis extending in the left-right direction, or rotate about an axis extending in the front-rear direction. The coverage area of the lid 213 may be larger than the opening of the box body 211, or the lid 213 may cover only part of the opening of the box body 211.

In one example, the lid 213 is a mesh surface, forming a protective net of the storage box 210 to prevent internal articles from falling out. The mesh surface may be made of soft plastic or woven fabric, or may be made of hard plastic. The mesh surface is fixed to the machine cover 114 by a snap-fit structure. In one example, the lid 213 may also be a sealing cover, which is a solid rigid cover. The lid 213 may also be a foldable sealing cover, which is not limited herein.

As shown in FIGS. 21 and 22, the storage box 210 is disposed behind the coupling portion 151. It can be understood that the battery pack 152 is disposed at the front end of the body 110, and the storage box 210 is disposed behind the battery pack 152, so that the battery pack 152 is arranged at the front, shifting the center of gravity of the entire machine forward, ensuring balance of the mower 100. Here, "the storage box 210 is disposed behind the coupling portion 151" may be understood as at least part of the storage box 210 is located behind the coupling portion 151. The lid 213 covers the box body 211 and also covers the opening of the recess 116, protecting the recess 116 from impurities such as dust contaminating the accommodation space. In one example, the lid 213 may be detached together with the box body 211 and used as a combination. In another example, the lid 213 may also be fixedly mounted to the machine cover 114 and can open or close the accommodation space of the recess 116 as a component of the mower 100.

In one example, the storage box 210 is disposed in front of the coupling portion 151. This may be understood as at least part of the storage box 210 is located in front of the coupling portion 151

In one example, the storage box 210 has a volume of 4-8 L. In one example, the storage box 210 has a volume of 2-10 L. In one example, the storage box has a volume of 5-7 L. Exemplarily, the storage box 210 has a volume of approximately 6 L; the length, width, and height of the storage box 210 are 360 mm × 320 mm × 150 mm. Exemplarily, the storage box 210 has a volume of 2 L, 3 L, 4 L, 5 L, 7 L, 8 L, 9 L, or 10 L.

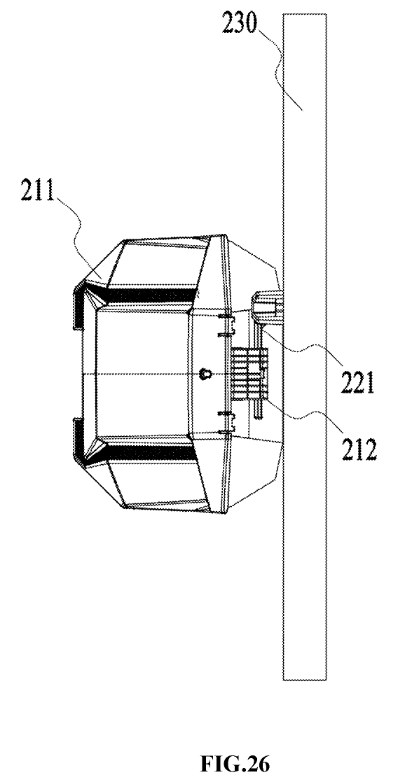

As shown in FIGS. 25 and 26, exemplarily, the hanging member 220 may be a hook 221. There may be one or more hooks 221. The engaging slot 212 may be a snap-fit member. The engaging slot 212 engages with the hook 221. The mounting portion 117 may be a protrusion formed on the machine cover 114. The engaging slot 212 can also engage with the mounting portion 117. FIG. 25 is a side view of the engaging slot 212 of the storage box 210 engaged with the hook 221. FIG. 26 is a top view of the storage box 210 suspended from the hook 221. The engagement connection between the engaging slot 212 and the hook 221 has a simple structure and is easy to operate.

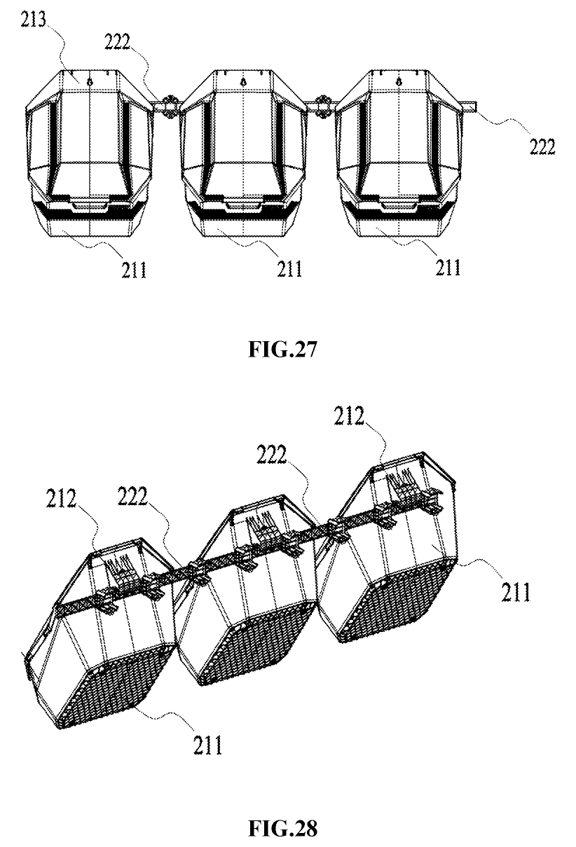

As shown in FIGS. 27 and 28, exemplarily, the hanging member 220 may also be a rail 222. The rail 222 is fixed to the wall 230. An end of the engaging slot 212 engages with the rail 222. One, two, three, or more storage boxes 210 can be suspended on a row of the rail 222. FIG. 27 shows three storage boxes 210 arranged and engaged on the rail 222. FIG. 27 is a front view of the engaging slot 212 of the storage box 210 engaged with the rail 222. FIG. 28 is a view of the engaging slot 212 of the storage box 210 engaged with the rail 222 from another perspective. A plurality of storage boxes 210 may be arranged in an expanded manner on the rail 222, and the storage boxes 210 may also move along the rail 222 to adjust the intervals and order of arrangement of the plurality of storage boxes 210.

As shown in FIG. 27, when the storage box 210 is suspended on the hanging member 220, the lid 213 may be used together with the box body 211 as a whole. It can be understood that when the storage box 210 is suspended, the lid 213 is snap-fitted on the box body 211, protecting the articles in the box body 211 from falling off and keeping the space visually neat.

In one example, the walk-behind mower 100 further includes a spraying device. The spraying device can be used for spraying pesticides, seeds, water, or fertilizers. The spraying device includes an outlet allowing the substance to be sprayed to flow out. The outlet is disposed on one side of the storage box 210 and communicates with the accommodation space inside the storage box 210. The storage box 210 contains the substance to be sprayed, and the substance to be sprayed flows from the storage box 210 to the outlet and flows out. The substance to be sprayed may be liquid or solid. In one example, the spraying device further includes a spray nozzle and a spray controller for controlling the opening and closing of the nozzle; the nozzle draws water or pesticide from the storage box 210. The body 110 is provided with a power supply interface that connects to a power interface of the spraying device to supply power to the spraying device. The spraying device draws the substance to be sprayed from the storage box 210 through the spray nozzle for spraying.

The storage box 210 can also be detached from the recess 116 of the body 110 and placed separately to store accessories and tools of the mower 100 or as a storage box for other articles.

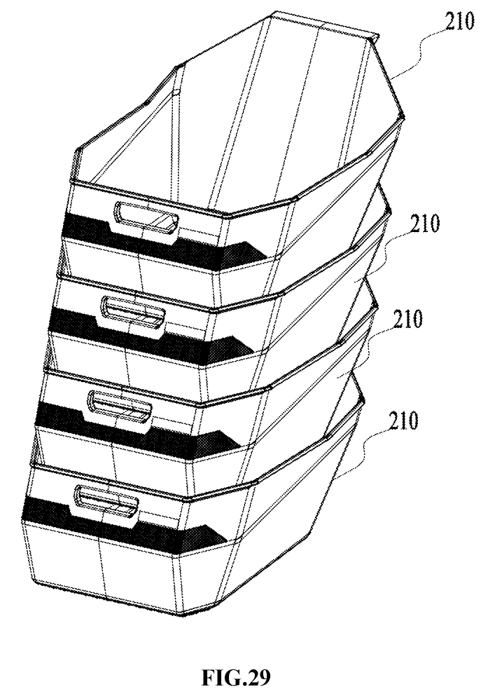

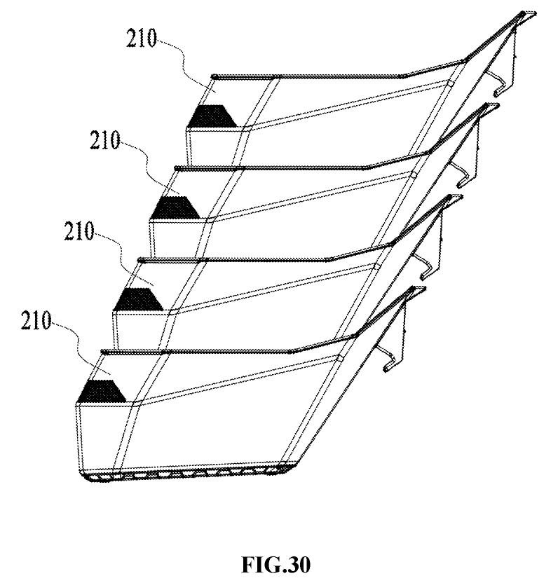

As shown in FIGS. 29 and 30, when a plurality of storage boxes 210 are placed separately, the plurality of storage boxes 210 can be stacked together, saving storage space. A plurality of storage boxes 210 means more than one storage box 210. The area of the upper opening of the storage box 210 is greater than the area of the bottom of the storage box 210. At least part of an upper storage box 210 can be received in the accommodation space of a lower storage box 210. A plurality of storage boxes 210 are stacked layer by layer, saving space occupied. Exemplarily, as shown in FIGS. 29 and 30, four storage boxes 210 are sequentially stacked from bottom to top. In another example, the area of the upper opening of the storage box 210 is smaller than or equal to the area of the bottom of the storage box 210, and the upper storage box 210 is directly placed on the lower storage box 210, and each layer of storage boxes 210 can still store articles.

In one example, a plurality of storage boxes 210 can be arranged in an expanded manner. Each storage box 210 is provided with matching positioning portions on its side edges. When a plurality of storage boxes 210 are aligned, adjacent storage boxes 210 are fixed and positioned by the positioning portions. A plurality of storage boxes 210 can be arranged in an expanded manner along the length direction or along the width direction, providing neat arrangement and visual tidiness.

In one example, when a plurality of storage boxes 210 are stacked or arranged in an expanded manner, the storage boxes 210 and the lids 213 can be used together. Exemplarily, after a plurality of storage boxes 210 are stacked layer by layer, the lid 213 is arranged on the uppermost storage box 210, or each storage box 210 is covered with a lid 213 before being stacked or arranged in an expanded manner.

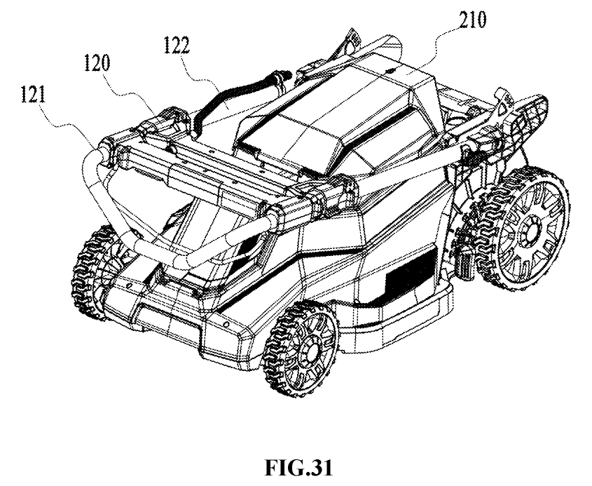

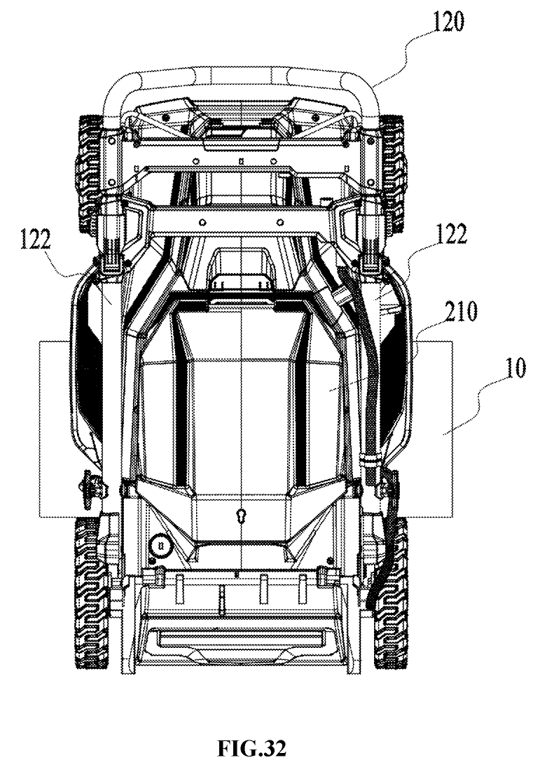

Specifically, when the storage box 210 is mounted on the mower 100, during the folding process of the handle assembly 120, the handle assembly 120 and the storage box 210 do not interfere with each other, i.e., the handle assembly 120 and the storage box 210 do not contact or collide with each other at any folding position from the beginning of folding to complete folding of the handle assembly 120. FIGS. 31 and 32 are schematic views of the handle assembly 120 in a folded state. As shown in FIGS. 31 and 32, when the handle assembly 120 is in the folded state, the storage box 210 is located within the space defined by the two parallel connecting rods 122 and the grip portion 121. A plane formed by the top of the storage box 210 along the horizontal direction is located above a plane formed by the connecting rods 122. In a top view, the projection of the storage box 210 on the horizontal plane 10 falls within the range defined by the projection of the connecting rods 122. The entire storage box 210 is inside the two connecting rods 122. It should be noted that the "storage box 210" described here may refer to the box body 211 alone or the assembly of the box body 211 covered with the lid 213. In the present disclosure, the horizontal plane 10 may be understood as a plane formed along the horizontal direction, or a plane parallel to the horizontal ground.

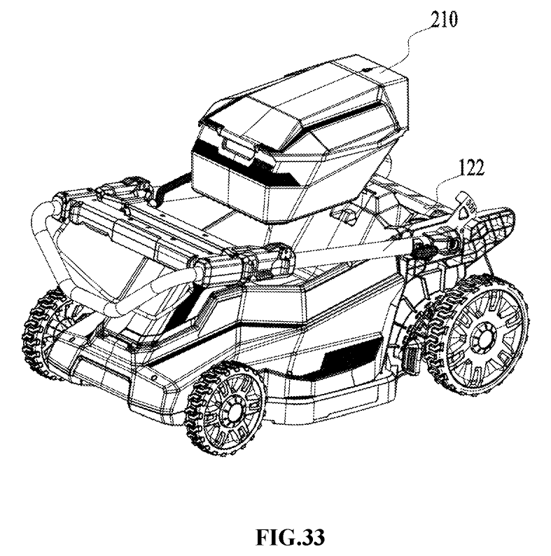

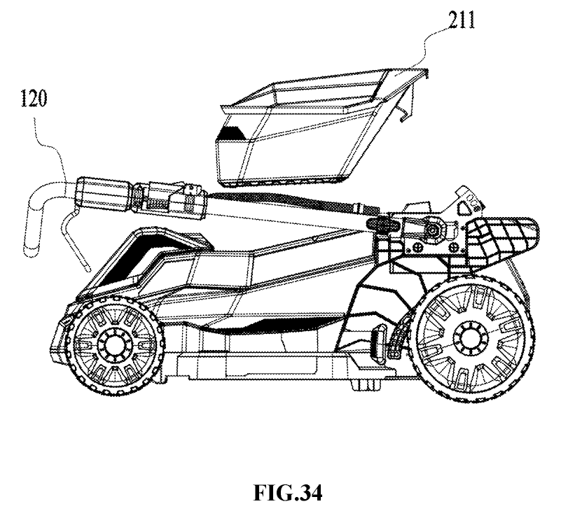

As shown in FIG. 33, when the handle assembly 120 is folded, the storage box 210 can be freely removed or mounted without interfering with the handle assembly 120 in the folded state, and the assembly and disassembly of the storage box 210 are not affected. In FIG. 33, the storage box 210 is an assembly formed by the lid 213 and the box body 211 engaged with each other. The storage box 210 may also be the box body 211 alone. As shown in FIG. 34, the box body 211 can be freely removed or mounted, and the handle assembly 120 does not affect the assembly and disassembly of the box body 211.

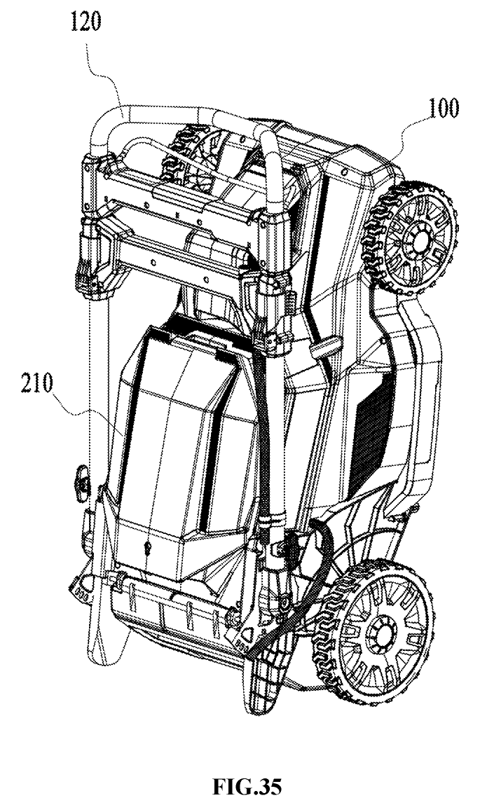

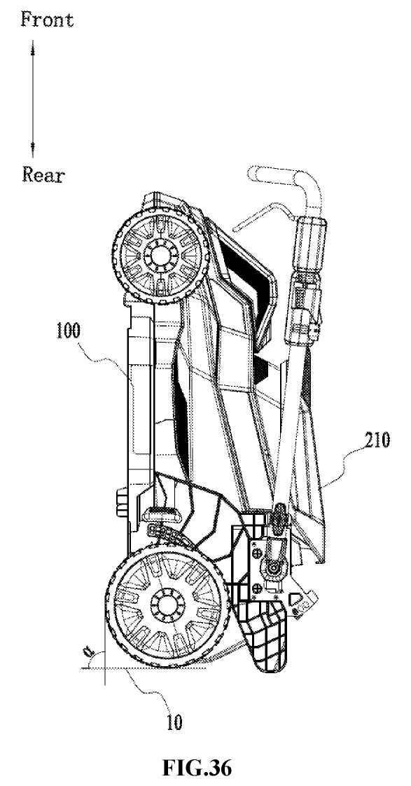

In practical application of the mower 100, when the mower 100 is stored, the handle is usually folded and the entire machine is stored upright. In some examples, as shown in FIGS. 35 and 36, when the entire mower 100 is stored upright, the storage box 210 does not fall off under the action of gravity alone, so that the mower 100 can be conveniently stored upright. It should be noted that when the mower 100 is stored upright, the angle α between the front-rear direction of the mower 100 and the horizontal plane 10 is greater than 0 degrees and less than 180 degrees. In some examples, the angle α is greater than or equal to 30 degrees and less than or equal to 90 degrees. In some examples, the angle α is greater than or equal to 60 degrees and less than or equal to 120 degrees. Preferably, the angle α is greater than or equal to 60 degrees and less than or equal to 90 degrees. As shown in FIG. 36, when the entire mower 100 is stored vertically upright (the angle α is 90 degrees), the storage box 210 does not slide out of the recess 116. The storage box 210 may refer to the box body 211 alone or the assembly of the box body 211 covered with the lid 213. When the mower 100 is stored upright, the storage box 210 does not fall off under the action of gravity alone without external force.

In some examples, the storage box 210 further includes a bracket 214 that helps to secure rod-shaped articles. The bracket 214 is detachably connected to the box body 211, for example, the bracket 214 is detachably mounted to the box body 211 by bolts, facilitating replacement of components. In another example, the bracket 214 is integral with the box body 211, for example, the bracket 214 is integrally formed with the box body 211, or the bracket 214 is fixedly connected to the box body 211 by a fastener. When a rod-shaped article 240 such as a branch is placed in the storage box 210, the rod-shaped article 240 at least partially extends beyond the edge of the box body 211, making it easy for the rod-shaped article 240 to fall off. Installing the bracket 214 on the storage box 210 helps secure the rod-shaped article 240, making it less likely to fall out.

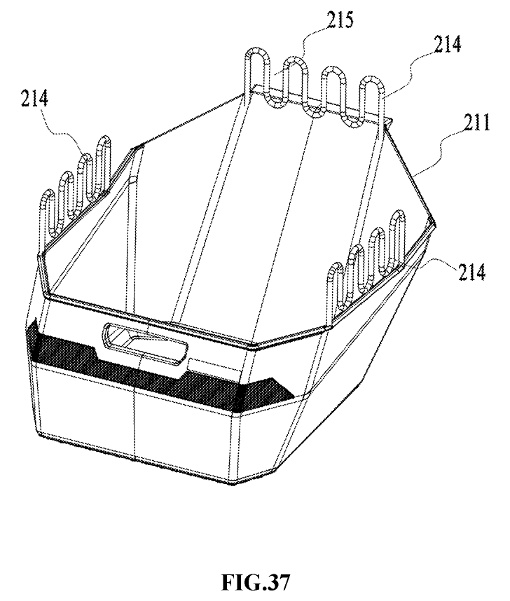

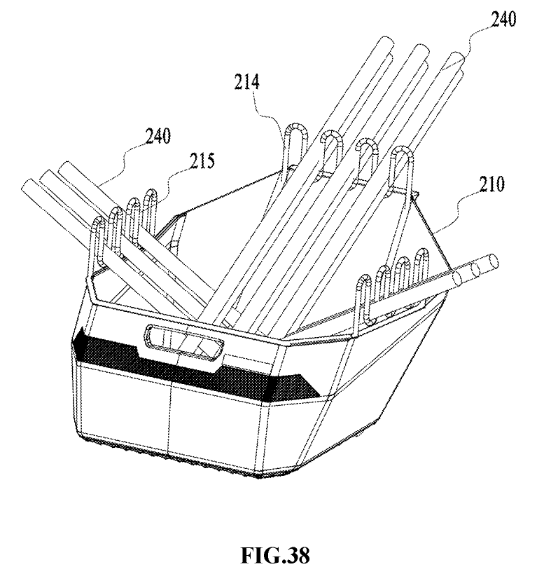

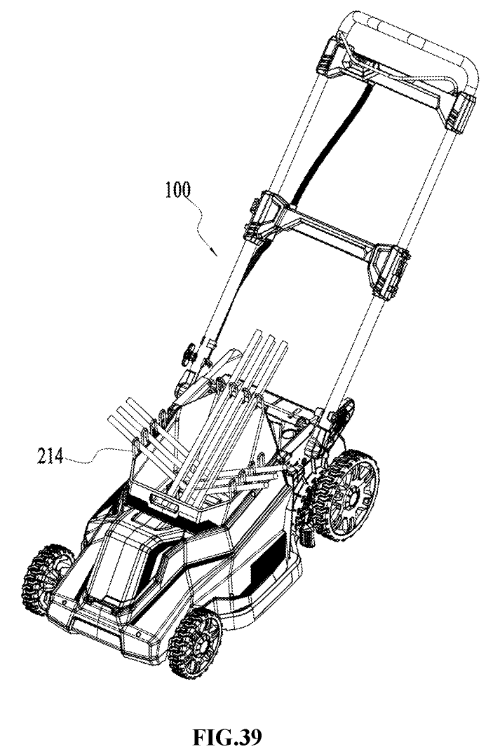

As shown in FIG. 37, at least one bracket 214 is mounted to the edge of the box body 211. The bracket 214 is formed with a groove 215 for constraining the rod-shaped article 240. As shown in FIGS. 38 and 39, when the rod-shaped article 240 is placed in the box body 211, one end of the rod-shaped article 240 is inserted into the groove 215. The groove 215 can limit and constrain the rod-shaped article 240, making it difficult to fall off from the box body 211. Exemplarily, the bracket 214 may be a wire bracket. The wire bracket is bent to form a plurality of grooves 215 for receiving rod-shaped articles 240. The wire brackets are mounted on three side edges of the box body 211. It can be understood that the rod-shaped article 240 may be fixed with one end placed in the box body 211 and the other end inserted into the groove 215, or both ends may be inserted into the grooves 215 of the brackets 214 on different sides. The specific placement is not limited, as long as the bracket 214 prevents the rod-shaped article 240 such as a branch placed in the storage box 210 from falling off.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A storage system for a mower, comprising:
a mower;
a storage box; and
a hanging member configured to be fixedly mounted to a wall;
wherein the mower comprises:
a body comprising a wheel assembly and a cutting assembly, the wheel assembly comprising front wheels and rear wheels, the cutting assembly comprising a motor and a cutting blade driven by the motor to rotate, the body further comprising a coupling portion configured to detachably receive a battery pack to supply power to the motor, the body further comprising a mounting portion configured to mount the storage box; and
wherein the storage box comprises:
a box body, the box body being formed with or connected with an engaging slot matching the hanging member, such that the box body can be suspended on the hanging member.

2. The storage system of claim 1, wherein the hanging member is a hook or a rail.

3. The storage system of claim 1, wherein the engaging slot is capable of engaging with the mounting portion and the hanging member respectively.

4. The storage system of claim 1, wherein the storage box further comprises a lid.

5. The storage system of claim 4, wherein the lid is snap-fitted with the box body, rotatably opened and closed with respect to the box body, or slidably opened and closed with respect to the box body.

6. The storage system of claim 4, wherein the storage box is disposed behind the coupling portion.

7. The storage system of claim 1, wherein the storage box has a volume of 4-8 L.

8. The storage system of claim 1, wherein the mower comprises a handle assembly, and when the handle assembly is in a folded state, the storage box can be freely removed or mounted without interfering with the handle assembly in the folded state.

9. The storage system of claim 1, wherein when the mower is stored upright, the storage box does not fall off.

10. The storage system of claim 1, wherein the storage box further comprises a bracket configured to secure a rod-shaped article.

11. The storage system of claim 10, wherein the bracket is integrally formed with or detachably connected to the box body.

12. The storage system of claim 1, wherein after the storage box is detached from the body, a plurality of storage boxes can be stacked or arranged in an expanded manner.

13. A walk-behind mower, comprising:
a body comprising a wheel assembly and a cutting assembly, the wheel assembly comprising front wheels and rear wheels, the cutting assembly comprising a motor and a cutting blade driven by the motor to rotate, the body further comprising a coupling portion configured to detachably receive a battery pack to supply power to the motor;
a handle assembly connected to the body for a user to operate the walk-behind mower from a rear side of the walk-behind mower; and
a storage box disposed on the body;
wherein a machine cover of the body is formed with a recess to receive the storage box, and the storage box is detachably mounted to the body.

14. The walk-behind mower of claim 13, further comprising a lid disposed above the storage box.

15. The walk-behind mower of claim 13, wherein the lid is a mesh surface.

16. The walk-behind mower of claim 13, wherein the lid is rotatably or slidably opened and closed with respect to the storage box.

17. The walk-behind mower of claim 13, wherein the storage box is disposed in front of or behind the coupling portion.

18. The walk-behind mower of claim 13, wherein the recess is configured to selectively receive the storage box or articles directly.

19. The walk-behind mower of claim 13, wherein when the handle assembly is folded, the storage box can be freely removed or mounted without interfering with the handle assembly in the folded state.

20. The walk-behind mower of claim 13, the body further comprising a mounting portion configured to mount the storage box, and when the walk-behind mower is stored upright, the storage box does not fall off.
